(19) United States
(12) Patent Application Publication
(10) Pub. No.: US 2021/0080779 A1
(43) Pub. Date: Mar. 18, 2021

(54) Display Panel and Display Device

(71) Applicant: WUHAN CHINA STAR OPTOELECTRONICS TECHNOLOGY CO., LTD., Wuhan, Hubei (CN)

(72) Inventor: Fancheng LIU, Wuhan, Hubei (CN)

(21) Appl. No.: 16/650,060

(22) PCT Filed: Nov. 12, 2019
(86) PCT No.: PCT/CN2019/117455

§ 371 Date: Mar. 24, 2020

(30) Foreign Application Priority Data
Sep. 12, 2019 (CN) 201910861844.8

(51) Int. Cl. G02F 1/1335; G02F 1/13357

(52) U.S. Cl. CPC G02F 1/133512; G02F 2001/133607; G02F 1/133606

(57) ABSTRACT

The present disclosure provides a display panel and a display device. The display panel includes a backlight module, a liquid crystal dimming layer, and a liquid crystal display layer sequentially disposed in a stack from bottom to top. The liquid crystal dimming layer includes a light alignment layer and a plurality of polymer-dispersed liquid crystal layers. The light alignment layer is provided with a grid shape to divide the liquid crystal dimming layer into a plurality of microcavities. The display device includes the display panel.

### FIELD OF INVENTION

The present disclosure relates to the field of display technologies, and more particularly, to a display panel and a display device.

### BACKGROUND OF INVENTION

Currently, display devices light up a specific area of a display panel by emitting light from a backlight module which passes through a liquid crystal layer corresponding to the specific area. Since light is scattered in a surrounding region of the specific area, this causes a phenomenon of “yellow edge border”, which seriously affects display quality of a screen.

On one hand, as shown in FIG. 1, if the backlight module uses a direct-type sub-millimeter light-emitting diode (Mini-LED) lamp board, which includes multiple areas arranged in an array such as area 1 to area 25, to implement a local dimming display, an illuminated area 13 is equivalent to a point light source, and light is scattered to surrounding unlit areas 7, 8, 9, 12, 14, 17, 18, and 19, thereby causing the phenomenon of “yellow edge border”.

On the other hand, as shown in FIG. 2, if the backlight module uses a side-type backlight module 91 and a polymer-dispersed liquid crystal layer (PDLC) 92 to implement a side-type display to light the specific area, a whole side-type backlight module 91 emits light including wide-angle light, and this structure cannot eliminate stray light and wide-angle interference light. To be more specific, when light passes through an illuminated area 922, it enters the polymer-dispersed liquid crystal layer and is scattered to surrounding areas such as unlit areas 921 and 923, thereby causing the phenomenon of “yellow edge border” of the liquid crystal display panel 93, wherein a light propagation path is indicated by an arrow.

Therefore, it is urgent to propose a display panel and a display device to solve the above technical problems.

### SUMMARY OF INVENTION

The object of the present disclosure is to provide a display panel and a display device, which can prevent the light emitted by the backlight module from entering the liquid crystal layer, thereby reducing the crosstalk between the areas when the area is lighting and displaying, preventing a “yellow edge border” phenomenon, and increasing the contrast during the local dimming displaying.

To achieve the above object, the present disclosure provides a display panel including a backlight module, a liquid crystal dimming layer, and a liquid crystal display layer sequentially cascading disposed from bottom to top. Specifically, the liquid crystal dimming layer disposed on the backlight module, the liquid crystal display layer disposed on the liquid crystal dimming layer. The liquid crystal dimming layer includes a light alignment layer and a plurality of polymer-dispersed liquid crystal layers. The light alignment layer provided with a grid shape to divide the liquid crystal dimming layer into a plurality of microcavities, wherein the light alignment layer is configured to support and block light, and the plurality of polymer-dispersed liquid crystal layers correspondingly filled in the plurality of microcavities.

Further, the light alignment layer includes a plurality of first light-shielding walls and a plurality of second light-shielding walls. Specifically, the plurality of first light-shielding walls extending along a first direction, wherein the plurality of first light-shielding walls are sequentially arranged along a second direction, and the first direction is different from the second direction; and the plurality of second light-shielding walls extending along the second direction, wherein the plurality of second light-shielding walls are sequentially arranged along the first direction, and the first light-shielding walls and the second light-shielding walls are staggered to form the plurality of microcavities in the grid shape.

Further, the plurality of first light-shielding walls and the plurality of second light-shielding walls are integrally formed.

Further, a ratio of width to height of the first light-shielding wall or the second light-shielding wall ranges from (1:100) to (2:1)

Further, a height of the first light-shielding wall or the second light-shielding wall ranges from 10 um to 50 um.

Further, the liquid crystal dimming layer further includes an electrode layer disposed below the light alignment layer.

Further, a material of the light alignment layer includes a photoresist material, and the photoresist material includes a resin polymer.

Further, the backlight module includes one of a blue light backlight board, a sidelight backlight module, or a direct-type sub-millimeter light-emitting diode backlight module.

Further, a material of the polymer-dispersed liquid crystal layer includes a scattering-type liquid crystal, and the scattering-type liquid crystal includes a plurality of liquid crystal molecules and network polymer.

The present disclosure also provides a display device including the display panel described above.

The beneficial effect of the present disclosure is to provide a display panel and a display device, in which a light alignment layer provided instead of a traditional support pillar is configured to support and block light, preventing light emitted by a backlight module from entering a liquid crystal layer, thereby reducing crosstalk between areas when the areas are lighting and displaying, preventing a phenomenon of “yellow edge border”, and increasing a contrast of local dimming display.

### DESCRIPTION OF FIGURES

FIG. 1 shows a schematic diagram of a planar structure of a conventional backlight module of a display panel using a direct-type sub-millimeter light-emitting diode lamp board.

FIG. 2 shows a schematic structural diagram of a conventional backlight module of a display panel using a side-type backlight module.

FIG. 3 shows a cross-sectional diagram of a display panel according to an embodiment of the present disclosure.

FIG. 4 shows a schematic diagram of a planar structure of a display panel according to an embodiment of the present disclosure, which mainly reflects a schematic diagram of a planar structure of a plurality of microcavities.

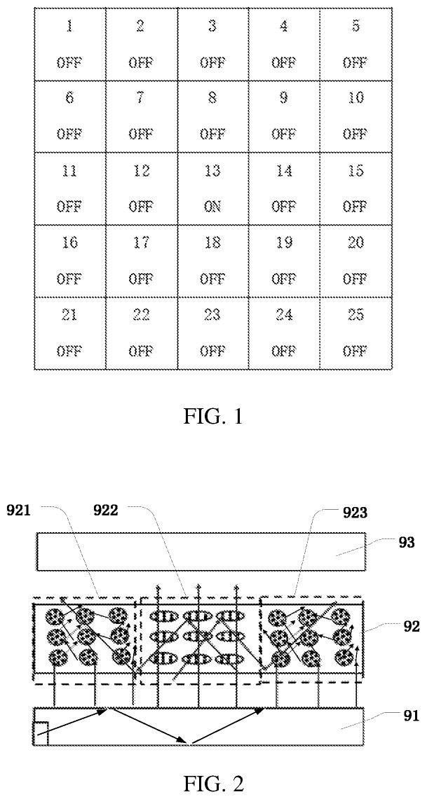

### DETAILED DESCRIPTION OF PREFERRED EMBODIMENTS

The following is a description of each embodiment with reference to additional figures to illustrate specific embodiments in which the present disclosure can be implemented. The directional terms mentioned in the present disclosure, such as up, down, front, back, left, right, inside, outside, side, etc., are only directions referring to the figures. The names of the elements mentioned in the present disclosure, such as first, second, etc., are only used to distinguish different components, which can be better expressed. In the figure, similarly structured units are denoted by the same reference numerals.

Embodiments of the present disclosure will be described in detail herein with reference to the figures. The invention may take many different forms, and the invention should not be construed as merely the specific embodiments set forth herein. The embodiments are provided to explain the practical application of the present disclosure so that those skilled in the art can understand various embodiments of the present disclosure and various modifications suitable for a specific intended application.

In the description of the present disclosure, it should be noted that the terms “installation”, “linked”, and “connected” should be understood in a broad sense unless explicitly stated and limited otherwise. For example, it can be fixed connection, removable connection, or integral connection; it can be mechanical or electrical connection; it can be directly connected, indirectly connected through an intermediate medium, or it can be an internal communication of two elements. For those of ordinary skill in the art, the specific meanings of the above terms in the present disclosure can be understood on a case-by-case basis.

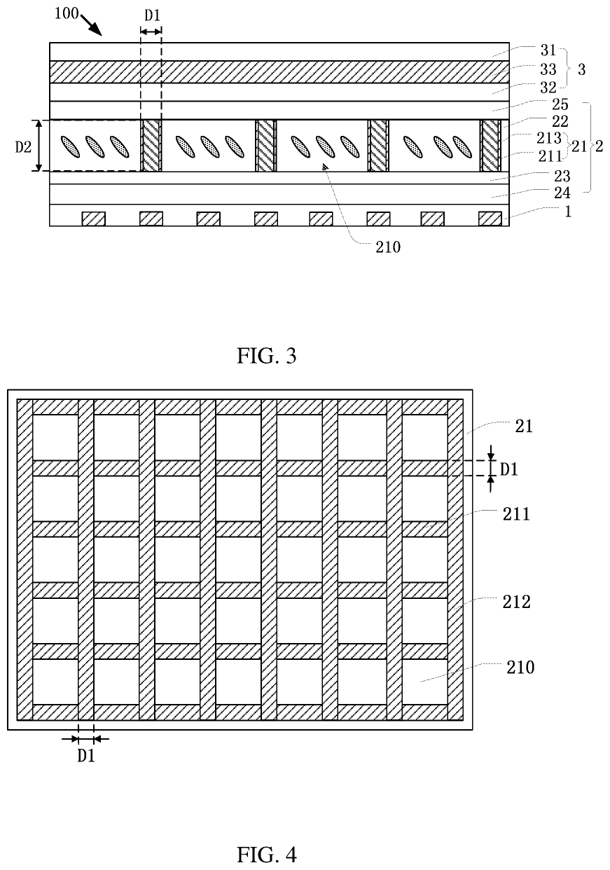

Referring to FIG. 3, the present disclosure provides a display panel 100 including a backlight module 1, a liquid crystal dimming layer 2, and a liquid crystal display layer 3 sequentially disposed in a stack from bottom to top. Specifically, the liquid crystal dimming layer 2 is disposed on the backlight module 1, and the liquid crystal display layer 3 is disposed on the liquid crystal dimming layer 2. The liquid crystal dimming layer 2 includes a light alignment layer 21 and a plurality of polymer-dispersed liquid crystal layer 22. The light alignment layer 21 is provided with a grid shape to divide the liquid crystal dimming layer 2 into a plurality of microcavities 210. The light alignment layer 21 provided instead of a traditional support pillar is configured to support and block light. The plurality of polymer-dispersed liquid crystal layers 22 are correspondingly filled in the plurality of microcavities 210. In one embodiment, the light alignment layer 21 provided instead of the traditional support pillar is configured to support and block light, which prevents light emitted by the backlight module 1 from entering the liquid crystal layer of a non-lighting partition during area lighting display, thereby reducing crosstalk between areas when the areas are lighting and displaying, preventing a phenomenon of “yellow edge border”, and improving a contrast during the area lighting display.

Please refer to FIG. 4. In one embodiment, the light alignment layer 21 includes a plurality of first light-shielding walls 211 and a plurality of second light-shielding walls 212. Specifically, the plurality of first light-shielding walls 211 extend along a first direction, wherein the plurality of first light-shielding walls 211 are sequentially arranged along a second direction, and the first direction is different from the second direction. The plurality of second light-shielding walls 212 extend along the second direction, wherein the plurality of second light-shielding walls 212 are sequentially arranged along the first direction, and the plurality of first light-shielding walls 211 and the plurality of second light-shielding walls 212 are staggered to form the plurality of microcavities 210, which facilitate the plurality of polymer-dispersed liquid crystal layers 22 to correspondingly fill in the plurality of microcavities 210. In one embodiment, the first direction is perpendicular to the second direction. Each of the microcavities 210 forms a lighting partition, which is convenient for partition control during the area lighting display.

In one embodiment, the plurality of first light-shielding walls 211 and the plurality of second light-shielding walls 212 are integrally formed, which is convenient for forming a firm structure in a grid shape and playing a supporting role.

Please refer to FIG. 3 and FIG. 4. In one embodiment, a ratio of width D1 to height D2 of the first light-shielding walls 211 or the second light-shielding walls 212 ranges from 1:100 to 2:1. The width D1 refers to a lateral width of the first light-shielding wall 211 or the second light-shielding wall 212, because the wider the lateral width is, the greater an influence on light transmittance of the display panel 100; but if the width D1 is not wide enough, it is difficult to achieve a required vertical height D2 in a process. The height D2 is a thickness of the liquid crystal cell of the polymer-dispersed liquid crystal layer 22. In one embodiment, the light alignment layer 21 is used instead of the conventional support pillar, therefore, the height D2 of the first light-shielding walls 211 or the second light-shielding walls 212 determines the thickness of the liquid crystal cell of the polymer dispersed liquid crystal layer 22. Generally, when the ratio of width D1 to height D2 is less than 1:4, the process is relatively easy to implement; when the ratio of width D1 to height D2 is 1:10, the difficulty of the process is greatly increased. Hence, the ratio of width D1 to height D2 of the first light-shielding wall 211 or the second light-shielding wall 212 is preferably 1:1, which facilitates manufacturing and ensures the light transmittance.

In one embodiment, the height D2 of the first light-shielding wall 211 or the second light-shielding wall 212 ranges from 10 um to 50 um, that is, a height of a sidewall of the microcavity 210 ranges from 10 um to 50 um. The width D1 of the first light-shielding wall 211 or the second light-shielding wall 212 preferably ranges from 1 um to 100 um.

Please continue to refer to FIG. 3. In one embodiment, the liquid crystal dimming layer 2 further includes an electrode layer 23 disposed below the light alignment layer 21. The display panel 100 is provided with metal signal traces (not shown in figure), such as scanning lines and data lines, which are generally distributed in a vertical and horizontal direction, and the metal signal traces are opaque. The light alignment layer 21 is designed on the metal signal traces of the electrode layer 23. Preferably, a distribution of the light alignment layer 21 corresponds to a distribution of the metal signal traces of the electrode layer 23, which will reduce influence on the light transmittance of the light alignment layer 21, thereby reducing influence on the light effect of the display panel 100 of an entire display system.

The liquid crystal dimming layer 2 further includes a dimming lower substrate 24 and a dimming upper substrate 25. The dimming lower substrate 24 is disposed below the electrode layer 23, and the dimming upper substrate 25 is disposed on the light alignment layer 21.

An outer surface of the light alignment layer 21 is provided with a light-absorbing layer 213, that is, the light-absorbing layer 213 is provided on an outer surface of the first light-shielding wall 211 or the second light-shielding wall 212. The light-absorbing layer 213 can absorb light and further prevent wide-angle light, such as stray light and wide-angle interference light from entering the liquid crystal layer of the non-lighting partition during area lighting display, thereby reducing crosstalk between areas when the areas are lighting and displaying, preventing the phenomenon of “yellow edge border”, and improving the contrast during the area lighting display.

The liquid crystal display layer 3 includes a display upper substrate 31, a display lower substrate 32, and liquid crystals 33 between the display upper substrate 31 and the display lower substrate 32. The liquid crystal 33 includes a thermotropic liquid crystal or a lyotropic liquid crystal, and a material of the liquid crystal 33 includes a biphenyl liquid crystal, a phenyl cyclohexane liquid crystal, or an ester liquid crystal.

In one embodiment, a material of the light alignment layer 21 includes a photoresist material or other resin materials, and the photoresist material includes a resin polymer.

In one embodiment, the backlight module 1 includes one of a blue light backlight board, a sidelight backlight module, or a direct-type sub-millimeter light-emitting diode backlight module. In one embodiment, the direct-type sub-millimeter light-emitting diode backlight module is preferably used. The direct-type backlight module can drive a certain number of small blocks to form a backlight region, which is easy to control a light source during the area lighting display.

In one embodiment, a material of the polymer-dispersed liquid crystal layer 22 includes a scattering-type liquid crystal. The scattering-type liquid crystal includes a plurality of liquid crystal molecules and network polymer and can switch between a transparent state and a screen display state.

The liquid crystal display layer 3 includes ordinary liquid crystals. After applying a voltage, the liquid crystal molecules rotate to control the light transmittance to achieve display on a gray-scale. Because the polymer-dispersed liquid crystal layer 22 has some polymers added, a refractive index of liquid crystal molecules in the polymer-dispersed liquid crystal layer 22 is different from a refractive index of the network polymer. A refractive index difference between the surface of the liquid crystal and the network polymer can be controlled by the voltage, so that light is transmitted or scattered on both surfaces to achieve transparent or scattered states. In the transparent state, light can be transmitted, and in the scattered state, light can be scattered for displaying image. The polymer-dispersed liquid crystal layer 22 has a strong light scattering property, which scatters light by using the refractive index difference, and the contrast is a ratio of a light transmittance in the transmission state to a light transmittance in the scattering state. The higher the contrast, the better the area lighting effect.

The present disclosure further provides a display device, including the display panel 100 described above.

The display device in the embodiment of the present disclosure may be any product or component having a display function, such as a mobile phone, a tablet computer, a television, a display, a notebook computer, a digital photo frame, a navigator, and the like.

The advantage of the present disclosure is to provide a display panel and a display device, in which a light alignment layer provided instead of a traditional support pillar is configured to support and block light, preventing light emitted by a backlight module from entering a liquid crystal layer of the non-lighting partition, thereby reducing crosstalk between areas when the areas are lighting and displaying, preventing a phenomenon of “yellow edge border”, and increasing a contrast of local dimming display.

The above description only the preferred embodiments of the present disclosure. It should be noted that for those of ordinary skill in the art without departing from the principles of the present disclosure, several improvements and adjustments can be made, and these improvements and adjustments should also be considered in the protection scope of the present disclosure.

What is claimed is:

1. A display panel, comprising:
a backlight module;
a liquid crystal dimming layer disposed on the backlight module; and
a liquid crystal display layer disposed on the liquid crystal dimming layer;
wherein the liquid crystal dimming layer comprises:
a light alignment layer provided with a grid shape to divide the liquid crystal dimming layer into a plurality of microcavities, wherein the light alignment layer is configured to support and block light; and
a plurality of polymer-dispersed liquid crystal layers correspondingly fill in the plurality of microcavities.

2. The display panel as claimed in claim 1, wherein the light alignment layer comprises:
a plurality of first light-shielding walls extending along a first direction, wherein the plurality of first light-shielding walls are sequentially arranged along a second direction, and the first direction is different from the second direction; and
a plurality of second light-shielding walls extending along the second direction, wherein the plurality of second light-shielding walls are sequentially arranged along the first direction, and the plurality of first light-shielding walls and the plurality of second light-shielding walls are staggered to form the plurality of microcavities in the grid shape.

3. The display panel as claimed in claim 2, wherein the plurality of first light-shielding walls and the plurality of second light-shielding walls are integrally formed.

4. The display panel as claimed in claim 2, wherein a ratio of width to height of the first light-shielding wall or the second light-shielding wall ranges from 1:100 to 2:1.

5. The display panel as claimed in claim 2, wherein a height of the first light-shielding wall or the second light-shielding wall ranges from 10 um to 50 um.

6. The display panel as claimed in claim 1, wherein the liquid crystal dimming layer further comprises:
an electrode layer disposed below the light alignment layer.

7. The display panel as claimed in claim 1, wherein a material of the light alignment layer comprises a photoresist material, and the photoresist material comprises a resin polymer.

8. The display panel as claimed in claim 1, wherein an outer surface of the light alignment layer is provided with a light-absorbing layer.

9. The display panel as claimed in claim 1, wherein a material of the polymer-dispersed liquid crystal layer comprises a scattering-type liquid crystal, and the scattering-type liquid crystal comprises a plurality of liquid crystal molecules and network polymer.

10. A display device, comprising the display panel as claimed in claim 1.
